(19) United States
(12) Patent Application Publication
(10) Pub. No.: US 2009/0260252 A1
(43) Pub. Date: Oct. 22, 2009

(54) Infrared dehumidifier

(75) Inventor: Enrico Bellio, Santa Maria di Sala (VE) (IT)

Correspondence Address: Themis Law, 7660 Fay Ave Ste H535, La Jolla, CA, 92037, US

(73) Assignee: PIOVAN SPA, Santa Maria di Sala (VE) (IT)

(21) Appl. No.: 12/253,942

(22) Filed: Oct. 18, 2008

(30) Foreign Application Priority Data
Oct. 25, 2007 (IT) VE2007A000080

(51) Int. Cl. F26B 3/34; F26B 11/02

(52) U.S. Cl. 34/266; 34/108

(57) ABSTRACT

An infrared dehumidifier includes a hollow drum configured to rotate or oscillate around a longitudinal axis and one or more infrared heating lamps disposed inside the drum.

### FIELD

The present invention relates to equipment for processing plastic materials. More particularly, the present invention relates to an infrared dehumidifier for plastic or other materials.

### BACKGROUND

Various and different processes are used at present for manufacturing finished and semi-finished products from plastic materials, the most common of which are injection molding, blow molding and extrusion.

The raw plastic material is typically provided in granular form and, in order to ensure a high quality of the finished and semi-finished products, humidity must be avoided from the raw plastic material. Accordingly, the plastic material is conveyed through a dehumidifier before feeding into a plasticizing screw.

Infrared dehumidifiers are known and basically consist in devices for eliminating or reducing the humidity in the plastic material through the action of infrared heating lamps. Such infrared dehumidifiers typically include a material feed duct, a material outflow duct, and a container communicating with the feed and outflow ducts, the inside of which is provided with a screw, preferably with increasing pitch, and with one or more infrared heating lamps positioned inside the container and integral with it.

This screw rotates around its longitudinal axis and causes the material to move forward. At the same time, the infrared heating lamps cause the plastic material to become heated, dehumidified and prepared for the following processing step.

### SUMMARY

In order to improve the reliability of the dehumidifying process, a new type of infrared dehumidifier has been developed and constructed.

An infrared dehumidifier according to the present invention includes, as main parts, a drum positioned on a support frame and one or more infrared heating lamps, arranged inside the drum and configured for dehumidifying and preheating the material.

The drum is hollow, rotates around a substantially horizontal main axis, and is provided with a series of projections on its inner surface.

The material moves through the drum, remaining therein for a time sufficient to allow the material to become dehumidified by the action of the infrared heating lamps.

In one embodiment of the invention, the drum is substantially cylindrical in shape and rotates around a longitudinal axis due to the presence of one or more guides, positioned outside of the drum, and of motion transmission devices.

In another embodiment of the invention, the cross section of the drum has the shape of an arc of a circle and is positioned inside the support frame, such that the open portion of the drum faces upwards. Differently from the previous embodiment, the drum does not perform a 360° rotation, but oscillates, that is, rotates partially in an alternate pattern around its main axis.

In a preferred embodiment of the invention, the projections on the inner surface of the drum are substantially linear and arranged longitudinally on the inner surface of the drum, or, in an alternative embodiment, are arranged in a helical pattern, in order to favor the advancement of the material toward the outlet.

The support frame includes a material feed duct and a duct receiving the outflow of the material toward processing machines or a storage system, and further includes one or more movable elements or hinges for closing or opening the drum.

Such closing or opening elements, if required, can be equipped with one or more translating guides for ensuring an easy access to the drum and for facilitating maintenance.

The movable elements or hinges for closing or opening the drum are configured to allow maintenance and replacement of the infrared heating lamps.

In a method of use of an infrared dehumidifier constructed according to the principles of the present invention, the granulated material travels through the feed duct and is introduced in the drum, where the infrared heating lamps entirely or substantially remove the moisture from the material. The rotating or oscillating movement of the drum causes the exposure of a larger surface of the material to the dehumidifying action of the heating lamps. The treated granules advance toward the outflow duct and are conveyed toward the machines processing the granulated material.

An infrared humidifier according to the present invention may also include an inclination device applied to the support frame, that is, a device suited for raising one side of the support frame or of the drum, thereby inclining the drum and thus favoring the advancement of the material toward the outflow duct.

The inclination of the support frame by means of the inclination device may be adjusted and interrupted when required, thus ensuring a better regulation of the advancement of the material through the drum.

The main advantage of an infrared dehumidifier constructed according to the principles of the present invention resides in facilitating access to the drum by means of the movable elements that open or close the drum.

The drum is preferably cylindrical in shape but also may have a variety of other cross sections, for example may be oval or elliptic, in both cases being rotatable on a guide.

These and other advantages have been achieved through the construction of an infrared dehumidifier constructed according to the principles of the present invention, for example, through an infrared dehumidifier having a rotary hollow drum with one or more infrared heating lamps provided therein.

### BRIEF DESCRIPTION OF THE DRAWINGS

Features of exemplary infrared dehumidifiers according to the present invention will be described in detail in the following detailed description, with reference to the enclosed drawings depicting non-limiting examples.

FIG. 1a depicts a side perspective view of an exemplary infrared dehumidifier according to the present invention and FIG. 1b depicts a perspective section view of the dehumidifier of FIG. 1a.

FIG. 2 depicts a schematic representation of an exemplary infrared dehumidifier according to the present invention and further depicts an infrared humidifier having a device for inclining one side of the support frame.

FIG. 3a depicts a cross section of an exemplary infrared dehumidifier according to the present invention and FIG. 3b depicts a cross section of another exemplary infrared humidifier according to the present invention.

### DETAILED DESCRIPTION

Detailed descriptions of embodiments of the invention are provided herein. It should be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

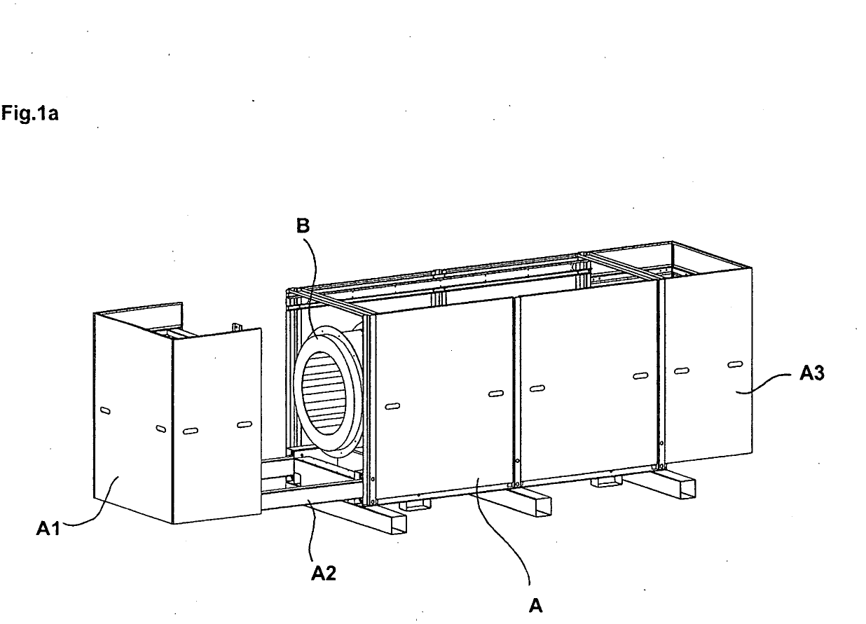

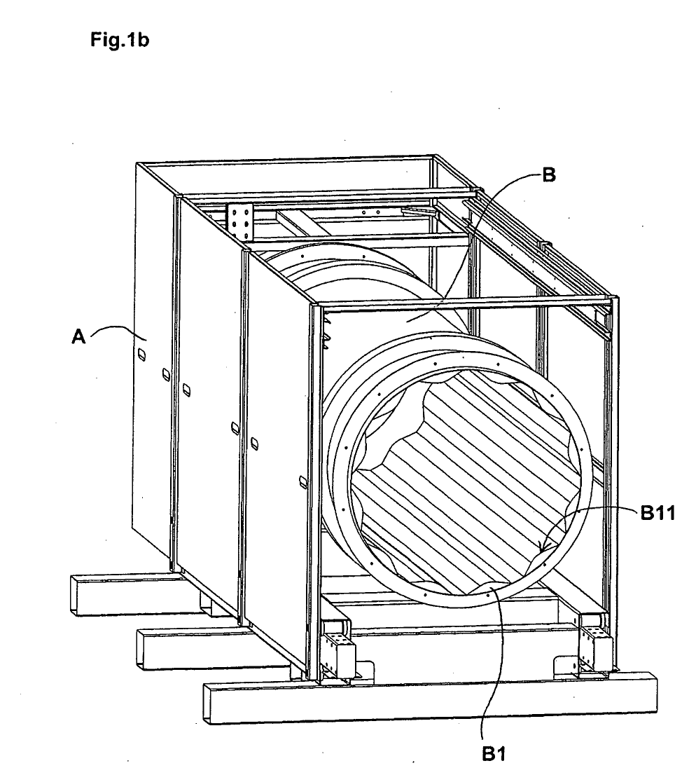

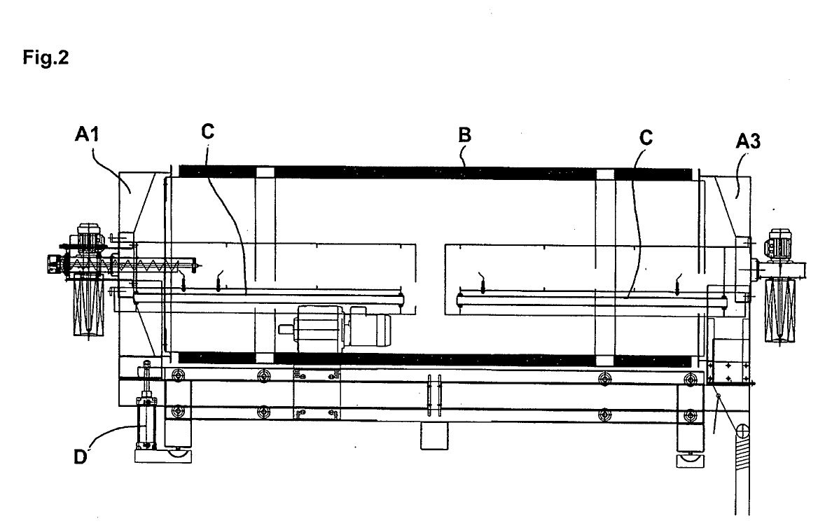

With reference to the embodiment depicted in FIGS. 1a-1b, an infrared dehumidifier constructed according to the principles of the present invention comprises, in its main parts, a support frame (A), a drum (B) connected to and positioned inside support frame (A), and one or more infrared heating lamps (C) (see FIG. 2) arranged inside the drum for dehumidifying and preheating the material.

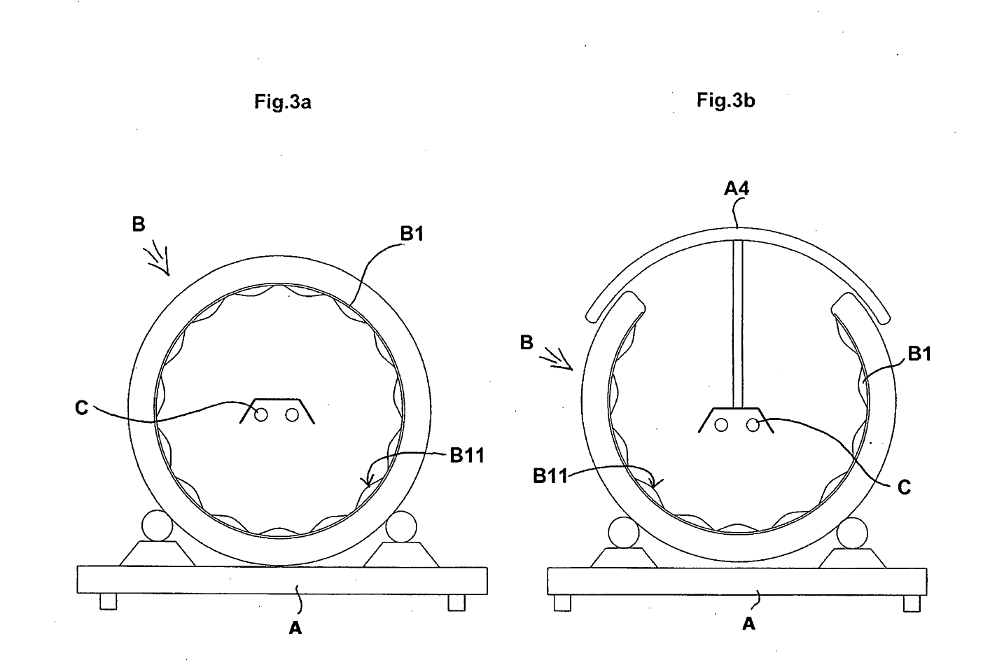

In an exemplary embodiment of the invention illustrated in FIG. 3a, drum (B) is substantially cylindrical, hollow, with open bases and a substantially horizontal axis of rotation. On the inner surface of the drum there are disposed a plurality of longitudinal projections (B1) spaced at regular intervals. Furthermore, drum (B) includes one or more guides on its outer surface, which are configured to enable drum (B) to rotate.

In this embodiment, projections (B1) are formed as substantially linear elements having an outer surface (B11) that is convex and having an inner surface that is contiguous and integral with the inner surface of drum (B).

Projections (B1) are made integral with drum (B) by means of one or more fastening elements such as screws or bolts.

A support frame (A), configured in this embodiment as substantially parallelepiped in shape, includes a material feed duct, a duct for the outflow of the material toward one or more resin processing machines and two or more movable elements (A1, A3) for closing or opening the drum (B), which are provided with translating guides (A2) to facilitate maintenance operations.

Each of movable elements (A1, A3) for closing or opening the drum (B) is arranged at the level of each of the open bases of rotary drum (B).

In particular, one of movable elements (A1) communicates with the material feed duct, while another one (A3) communicates with the outflow duct. In the preferred embodiment of the invention, infrared heating lamps (C) are coupled to movable elements (A1, A3) through fastening elements such as screws or bolts.

Thus, the granulated material travels through the feed duct and is introduced in rotary drum (B), where infrared heating lamps (C) provide energy for dehumidifying the granulated material. The rotary motion of drum (B) causes a larger surface of the material to the exposed to the dehumidifying action of heating lamps (C). The granules treated according to this process are successively conveyed to the machines processing the resin.

With reference to FIG. 2, an embodiment of the invention may further comprise a device (D) for inclining one side of support frame (A), that is, a device configured for raising the side of the support frame (A) where the material flows in, thereby inclining drum (B) and facilitating the advancement of the material toward the outflow duct. The inclination of support frame (A) by means of inclination device (D) can be adjusted and interrupted as required, thus ensuring a better regulation of the advancement of the material through drum (B).

In one embodiment of the invention, inclination device (D) includes or is a hydraulic piston.

FIG. 3b illustrates another embodiment of drum (B) of an infrared dehumidifier according to the present invention. In this embodiment, drum (B) has a cross section in the shape of an arc of a circle and is positioned within support frame (A), such that the open portion of drum (B) faces upwards. Differently from the previous embodiment, drum (B) as shown in FIG. 3 does not perform a 360° rotation, but oscillates, that is, rotates partially in an alternate pattern around its main axis. Closing element (A4) of the open portion of drum (B), in this case, includes an element substantially in the shape of an arc of a circle, positioned above said drum (B) and integral with said support frame (A), thereby enabling the relative oscillating movement of drum (B) in relation to closing element (A4). In this embodiment, the infrared heating lamps are connected to closing element (A4) by means of one or more fastening elements such as rods.

While the invention has been described in connection with a number of embodiments, it is not intended to limit the scope of the invention to the particular forms set forth, but on the contrary, it is intended to cover such alternatives, modifications, and equivalents as may be included within the scope of the invention.

With reference to the above description and the attached drawings, the following claims are expressed.

What is claimed is:

1. An infrared dehumidifier comprising:
a drum that is hollow and rotatable or configured to oscillate around a longitudinal axis of the drum, the drum being couplable to an inflow duct and to an outflow duct; and
one or more infrared heating lamps disposed within the drum.

2. The infrared dehumidifier of claim 1, wherein an inner surface of the drum comprises one or projections.

3. The infrared dehumidifier of claim 2, wherein the one or more projections are disposed in a longitudinal pattern.

4. The infrared dehumidifier of claim 2, wherein the one or more projections are disposed in a helical pattern.

5. The infrared dehumidifier of claim 2, wherein the one or more projections comprise a convex surface.

6. The infrared dehumidifier of claim 2, wherein the one or more projections are fastened to the inner surface of the drum.

7. The infrared dehumidifier of claim 1, wherein the drum is substantially cylindrical, and wherein bases of the drum are open or openable.

8. The infrared dehumidifier of claim 1, further comprising one or more movable elements for opening and closing the drum.

9. The infrared dehumidifier of claim 8, wherein the one or more movable elements comprise one or more translating guides for translating the one or more movable elements.

10. The infrared dehumidifier of claims 1, wherein a cross section of the drum is shaped as an arc of a circle and oscillates in relation to the longitudinal axis.

11. The infrared dehumidifier of claim 1, further comprising an inclination device directly or indirectly applied to the drum, wherein the inclination device is configured for raising one side of the drum, thereby regulating an advancement of a material within the drum.

12. The infrared dehumidifier of claim 11, wherein the inclination device comprises a hydraulic piston.

13. The infrared dehumidifier of claim 1, further comprising a support frame containing and supporting the drum.
